(19) United States
(12) Patent Application Publication
(10) Pub. No.: US 2005/0066089 A1
(43) Pub. Date: Mar. 24, 2005

(54) Consumption based source throttling

(76) Inventors: Jeyhan Karaoguz, Irvine, CA (US); James D. Bennett, San Clemente, CA (US)

Correspondence Address: MCANDREWS HELD & MALLOY, LTD, 500 WEST MADISON STREET, SUITE 3400, CHICAGO, IL, 60661, US

(21) Appl. No.: 10/875,894

(22) Filed: Jun. 24, 2004

Related U.S. Application Data
(60) Provisional application No. 60/504,868, filed on Sep. 22, 2003.

(51) Int. Cl. G06F 13/12

(52) U.S. Cl. 710/72

(57) ABSTRACT

A system and method for controlling communication between an information source and an information presentation system. Various aspects of the present invention provide apparatus, structure and method steps that receive an initial portion of information from the information source in an information stream characterized by initial stream characteristics. The initial portion of information may be presented to a user according to an initial set of presentation attributes. It may be determined that the user desires to consume a next portion of the information according to a next set of presentation attributes. Next, information stream characteristics are determined based on the next set of presentation attributes. The information source may then be directed to communicate the next portion of the information in an information stream characterized by the next information stream characteristics.

### CROSS-REFERENCE TO RELATED APPLICATIONS/INCORPORATION BY REFERENCE

This patent application is related to and claims priority from provisional patent application Ser. No. 60/504,868, filed Sep. 22, 2003, and titled “CONSUMPTION BASED SOURCE THROTTLING” (Attorney Docket No. 15209US01), the contents of which are hereby incorporated herein by reference in their entirety. This patent application is related to U.S. patent application Ser. No. ______ filed concurrently with the present application, and titled “CONSUMPTION BASED BANDWIDTH ARBITRATION” (Attorney Docket No. 15208US02).

### FEDERALLY SPONSORED RESEARCH OR DEVELOPMENT

[Not Applicable]

### SEQUENCE LISTING

[Not Applicable]

### [MICROFICHE/COPYRIGHT REFERENCE]

[Not Applicable]

### BACKGROUND OF THE INVENTION

In a dynamic network environment, communication bandwidth resources may be limited and the demand for such resources high. For example, a user output system that provides information to a user in human-perceivable form may have a fixed amount of communication bandwidth that the system may utilize to communicate with a variety of information source devices. Each of the information source devices may communicate information with the user output system, thereby utilizing respective portions of the fixed amount of communication bandwidth. Each of the information source devices may compete for and utilize respective portions of the fixed amount of communication bandwidth to communicate a fixed amount of information, whether or not the user is consuming all of the fixed amount of information using the system. For example, an information source device may utilize a portion of the fixed amount of communication bandwidth to communicate high-resolution video information when the user is only consuming a low-resolution video image.

Utilizing portions of the fixed amount of communication bandwidth for communicating more information than the user is currently consuming is generally wasteful of the communication bandwidth. Such unnecessary utilization of the limited amount of communication bandwidth may result in a deficiency of the available communication bandwidth that the system may utilize to provide the desired information to the user. Such unnecessary utilization of communication bandwidth may result, for example, in the user not being able to consume the information that the user desires or not being able to consume the information at the level of quality that the user desires.

Accordingly, a system and method that controls communications between an information source and an information presentation system based on the user's current information consumption environment is desirable.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and method are provided for controlling communication between an information source and an information presentation system. Various aspects of the present invention provide apparatus structure and method steps that receive an initial portion of information from the information source in an information stream characterized by initial stream characteristics. Such stream characteristics may comprise, for example, communication protocol, spatial and temporal resolution, data resolution, and encoding scheme.

Various aspects of the present invention may present the initial portion of information to a user according to an initial set of presentation attributes. A determination may be made that the user desires to consume a next portion of the information according to a next set of presentation attributes. Such presentation attributes may comprise, for example, window dimensions, spatial and temporal image resolution, data resolution, audio and video quality, and presentation priority. Next, information stream characteristics are determined based on the next set of presentation attributes. The information source is directed to communicate the next portion of the information in an information stream characterized by the next information stream characteristics.

Various aspects of the present invention provide apparatus structure and method steps that communicate an initial portion of information to an information presentation system in an information stream characterized by initial stream characteristics. An indication is received from the information presentation system to communicate a next portion of the information to the information presentation system in an information stream characterized by next stream characteristics. The next portion of the information is communicated to the information presentation system in an information stream characterized by the next stream characteristics.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a diagram illustrating a dynamic information consumption environment in accordance with various aspects of the present invention.

FIG. 2 is a diagram illustrating an information consumption environment incorporating consumption-based source throttling in accordance with various aspects of the present invention.

FIG. 3 is a diagram illustrating an information consumption environment incorporating consumption-based source throttling in accordance with various aspects of the present invention.

FIG. 4 is a diagram illustrating a first example of user information consumption in accordance with various aspects of the present invention.

FIG. 5 is a diagram illustrating a second example of user information consumption in accordance with various aspects of the present invention.

FIG. 6 is a diagram illustrating a third example of user information consumption in accordance with various aspects of the present invention.

FIG. 7 is a diagram illustrating a fourth example of user information consumption in accordance with various aspects of the present invention.

FIG. 8 is a flow diagram illustrating a method incorporating consumption-based source throttling in accordance with various aspects of the present invention.

FIG. 9 is a flow diagram illustrating a method incorporating consumption-based source throttling in accordance with various aspects of the present invention.

### DETAILED DESCRIPTION OF THE INVENTION

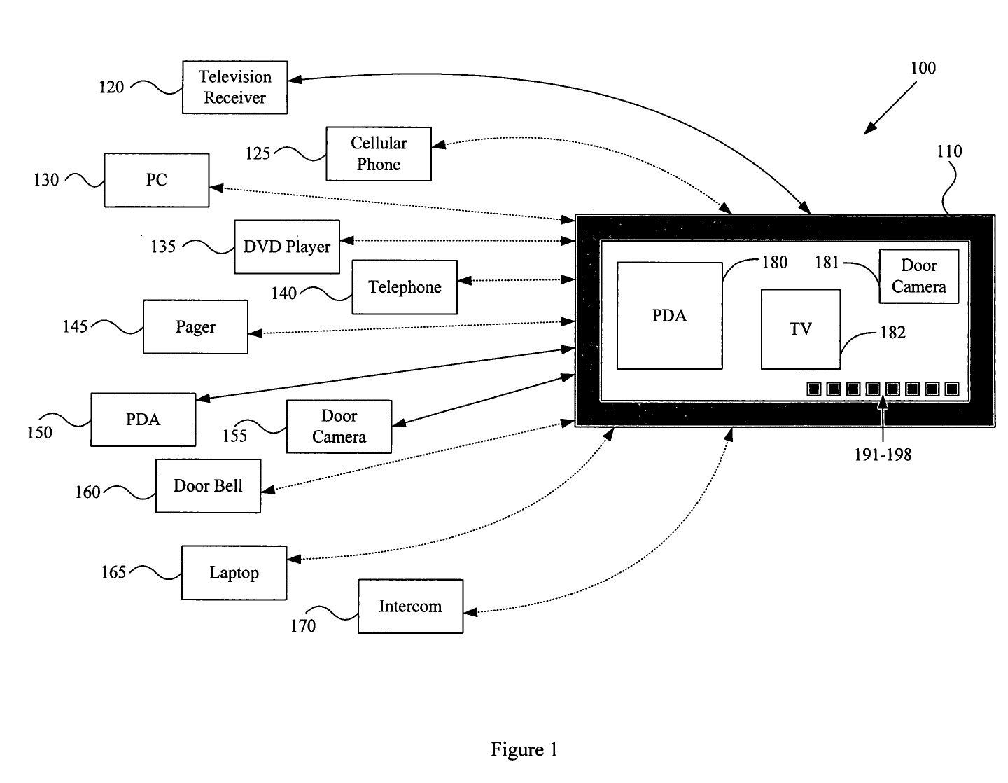

FIG. 1 is a diagram illustrating a dynamic information consumption environment 100 in accordance with various aspects of the present invention. The exemplary information consumption environment 100 includes an information presentation system 110. The information presentation system 110 may include, for example, an audio/visual display system, an audio presentation system, or other user output system that presents information to a user in human-perceivable form for consumption.

The information consumption environment 100 also includes a plurality of information source devices available within the environment 100 to provide information to the information presentation system 110. Such information source devices may include, for example and without limitation, a television receiver 120, a cellular phone 125, a personal computing system 130, a Digital Video Disk (DVD) player 135, a telephone system 140, a pager 145, a Personal Digital Assistant (PDA) 150, a door camera 155, a door bell 160, a laptop computer 165 and an intercom system 170. The environment 100 may also be referred to herein as a “network.”

Each of the information source devices may be communicating with or attempting to establish communications with the information presentation system 110. The information presentation system 110 may, for example, have windows (or screens) for providing visual information for user consumption. The information presentation system 110 may also, for example, have audio components for providing audio information for user consumption. The windows may display information from various information source devices. For example, various respective windows 180-182 may provide visual information to the user originating from the PDA 150, door camera 155 and television receiver 120, respectively. The information presentation system 110 may also, for example, provide icon-style indicia 191-198 to indicate information source devices that are available in the environment 100 to provide information.

The information source devices in the information consumption environment 100 may be capable of providing more information simultaneously to the information presentation system 110 than a user can consume, or desires to consume. Also, the information source devices in the environment 100 may be capable of providing more information simultaneously to the information presentation system 110 than the information presentation system 110 can effectively present to the user. Further, the information source devices in the environment 100 may also be capable of communicating more information to the information presentation system 110 than the available communication bandwidth between the information source devices and the information presentation system 110 can carry. Accordingly, intelligently managing such communications and communication resources is desirable.

For example, the information source devices may communicate information with the information presentation system 110 using one or more wireless standards, such as the Bluetooth, IEEE 802.11, or Ultra Wide Band (UWB) protocols. Such wireless standards have limited amounts of communication bandwidth, which can carry limited amounts of information. In such an exemplary wireless environment, the information source devices may all communicate information with the information presentation system 110 using a common communication band.

Various information source devices may communicate information or attempt to communicate information to the information presentation system 110 regardless of whether the user is interested in consuming their respective information. In such a situation, limited communication bandwidth and other communication resources may be wasted by communicating information in which the user has no present interest or a reduced present interest. Such unnecessarily utilized communication bandwidth and other communication resources may interfere with the user's consumption of desired information.

For example, an information source device may communicate high resolution information to the information presentation system 110 when the user is actually consuming the information at low resolution. In another example, an information source device may communicate information to the information presentation system 110 at a high communication priority when the user has actually specified a low priority for the information. In a further example, an information source device may communicate information to the information presentation system 110 using high quality encoding when the user is consuming the information using output apparatus that is not capable of presenting the information to the user in a high quality manner. In the preceding information consumption scenarios, the system may be wasting communication bandwidth that could be advantageously utilized for other communications.

Note that the information presentation system 110 including an audio/visual display system is but one example of a information presentation system that may provide human-perceivable information to a user for consumption. Accordingly, the scope of various aspects of the present invention should, by no means, be limited by characteristics of an audio/visual display system. In addition, though portions of the following discussion may generally refer to a wireless communication environment, which provides a convenient example of a communication environment with finite common communication bandwidth, the scope of various aspects of the present invention should, by no means, be limited by characteristics of a wireless communication environment. For example and without limitation, information source devices may communicate with an information presentation system using wired links, wireless (or RF) links, tethered optical links, and non-tethered optical links.

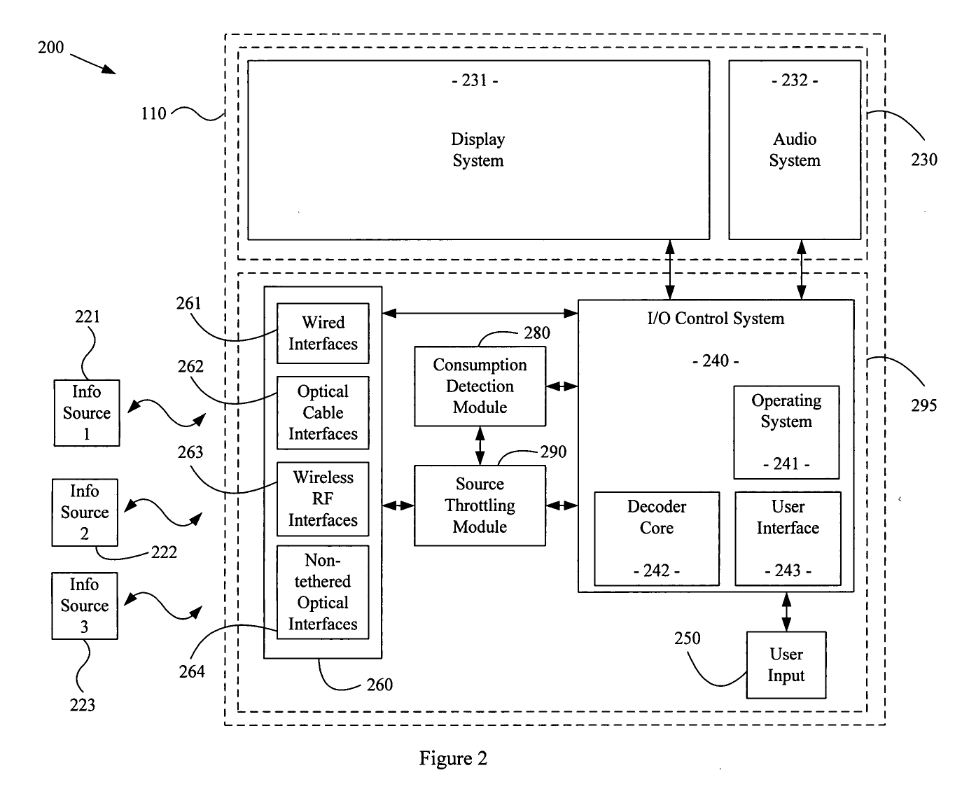

FIG. 2 is a diagram illustrating an exemplary information consumption environment 200 incorporating consumption-based source throttling in accordance with various aspects of the present invention. The information consumption environment 200 shows a more detailed illustration of the exemplary information presentation system 110 of FIG. 1, and also shows a plurality of exemplary information source devices 221-223. The exemplary information source devices 221-223 may, for example, be similar to the various information source devices illustrated in FIG. 1.

The information presentation system 110 includes an information output system 230, an I/O control system 240 and a user input system 250. The information presentation system 110 also includes a communication module 260, a consumption detection module 280 and a source throttling module 290. The exemplary I/O control system 240 includes an operating system module 241, a decoder core module 242 and a user interface module 243. The exemplary communication module 260 may include, for example, various communication interface modules, including a wired interface module 261, an optical cable interface module 262, a wireless RF interface module 263 and a non-tethered optical interface module 264.

The exemplary information source devices 221-223 provide information to the information presentation system 110. The information source devices 221-223 may provide a wide array of information types and forms to the information presentation system 110. For example, the information source devices 221-223 may provide video information to the information presentation system 110, such as, for example, VGA information, SVGA information, MPEG-2 information and MPEG-4 information. The information source devices 221-223 may provide audio information to the information presentation system 110, such as, for example, Dolby surround sound information, stereo information, WAV format information and MP3 information. The information source devices 221-223 may, for example, provide textual information to the information presentation system 110. Information source devices generally may provide to the information presentation system 110 any type of information that may be presented to a user in human perceivable form. Accordingly, the scope of various aspects of the present invention should, by no means, be limited to particular information types, encoding formats and communication protocols.

The communication module 260 generally includes apparatus to provide a communication interface between the information presentation system 110 and the various information source devices 221-223. The exemplary communication module 260 shown in FIG. 2 includes a wired interface module 261, optical cable interface module 262, wireless RF interface module 263 and non-tethered optical interface module 264.

The wired interface module 261 may provide a communication interface for the information source devices 221-223 using wired communication links. The optical cable interface module 262 may provide a communication interface for the information source devices using optical cable communication links. The wireless RF interface module 263 may provide a communication interface for information source devices using wireless RF communication links, such as, for example, wireless links based on Bluetooth, IEEE 802.11, and Ultra Wide Band (UWB). The non-tethered optical interface module 264 may provide a communication interface for information source devices using non-tethered optical communication links, such as, for example, infrared or ultraviolet communication links. The various exemplary interface modules 261-264 illustrated in FIG. 2 are exemplary interface modules, and should, by no means, limit the scope of various aspects of the present invention to particular communication link structures, methods or related apparatus.

In the exemplary information presentation system 110 illustrated in FIG. 2, the I/O control system 240 is coupled to the communication module 260 and the information output system 230. The I/O control system 240 may generally receive a signal from the communication module 260 indicative of information received from the information source devices 221-223 and output a signal to the information output system 230 to cause the information output system 230 to present the information received from the information source devices 221-223 in human perceivable form. The user may then consume the information as presented by the information output system 230.

The I/O control system 240 may, for example, include an operating system module 241 that performs various aspects of the interface between the communication module 260 and the information output system 230. The operating system module 241 may, for example, receive the signal from the communication module 260 indicative of received information from the information source devices and generate a corresponding signal to cause the information output system 230 to present the received information in human perceivable form. The operating system module 241 may further generate the corresponding signal to cause the information output system 230 to present the received information according to presentation attributes specified by the user.

The information output system 230 generally includes apparatus to present information to a user for consumption in human-perceivable form. The exemplary information output system 230 includes a display system 231 and an audio system 232. The display system 231 and audio system 232 are aspects of an exemplary information output system 230, and accordingly, should by no means limit the scope of various aspects of the present invention to particular user output devices. For example, the information output system 230 may alternatively include any of a variety of devices that present information to a user for consumption in human-perceivable form.

The information presentation system 110 includes a user input system 250. The exemplary user input system 250 illustrated in FIG. 2 may be communicatively coupled to the I/O control system 240. The I/O control system 240 may, for example, include a user interface module 243 communicatively coupled to the user input system 250 to manage communications between the user input system 250 and the I/O control system 240.

A user may utilize the user input system 250 to control various attributes of the presentation of information from the various information source devices 221-223 on the information output system 230. For example, the user may utilize the user input system 250 to control a cursor that the user interface module 243 and operating system module 241 cause the display system 231 to output. The user may manipulate such a cursor to indicate various presentation attributes for information being displayed on the display system 231.

The user may, utilizing the user input system 250, specify to the I/O control system 240 the quality or spatial/temporal resolution level at which the user desires to consume information. For example, the user may utilize the user input system 250 to specify that a first video output window on the display system 231 is one fourth the size of a second video output window on the display system 231. The user may also utilize the user input system 250 to specify to the I/O control system 240, priority levels for various information that the user is consuming. For example, the user may indicate priority level by explicitly assigning display windows priority rankings or may indicate priority level by layering various windows.

Generally, the user input system 250, user interface module 243 and operating system 241 may include a wide range of apparatus that provide a user the capability to select between various detected and available information source devices and control presentation characteristics for information. For example, the user input system 250 may include a mouse, trackball, or thumbwheel. The user input system 250 may have an on-board output device or the user may, for example, utilize aspects of the information output system 230 for user output and feedback. Accordingly, the scope of various aspects of the present invention should, by no means, be limited to particular user input apparatus configurations.

A user may, for example, via the user input system 250, indicate to the information presentation system 110 from which information source devices the user is interested in consuming information, specific information within the desired information source devices that the user is interested in consuming, or the presentation attributes with which the user desires the information presentation system 110 to present the information. The I/O control system 240 may then generate signals that reflect this user input. For example, the I/O control system 240 may utilize such user indications to perform various display changes on the display system 231. The I/O control system 240 may, for example, detect the user maximizing an icon on the display system 231. The I/O control system 240 may also, for example, detect the user changing the size of a window on the display system 231. The I/O control system 240 may also, for example, detect the user changing the window layering on the display system 231. The I/O control system 240 may further detect a change in the output device that the user desires to utilize. The I/O control system 240 may generally detect user indications indicative of the user's consumption of information on the information presentation system 110 and generate corresponding output signals.

The information presentation system 110 includes a consumption detection module 280 that is communicatively coupled to the I/O control system 240. The consumption detection module 280 may receive signals from the I/O control system 240 indicative of user selection of, for example, information source devices and specific information for consumption. The consumption detection module 280 may receive signals from the I/O control system 240 indicative of user modifications to the presentation attributes for the information, such as, for example, changes in selected windows, window size and window layering. The consumption detection module 280 may receive signals from the I/O control system 240 indicative of user specification or modification of the spatial or temporal resolution of presented information. The consumption detection module 280 may receive signals from the I/O control system 240 indicative of user specification or modification of the priority of various information presentations. The consumption detection module 280 may also receive signals from the I/O control system 240 indicative of the characteristics of output devices on which the information is being presented.

The consumption detection module 280 may process such signals to track the current state of user information consumption. For example, in a video display environment, the consumption detection module 280 may track which information sources the user has iconized and for which information sources the user has opened windows. The consumption detection module 280 may track the size and layering or priority of particular windows that the user is utilizing to consume information. The consumption detection module 280 may, for example, track the particular output devices that the user is utilizing to consume information. The consumption detection module 280 may generate a signal indicative of the current state of user information consumption and output such a signal to various devices and modules.

The information presentation system 110 includes a source throttling module 290. The source throttling module 290 may, for example, be communicatively coupled to the consumption detection module 280, communication module 260 and I/O control system 240. The source throttling module 290 may receive a signal from the consumption detection module 280 indicative of user information consumption (e.g., various information presentation attributes). Such presentation attributes may include, for example, window size, window layering, display resolution, sound quality, information priority, and various spatial and temporal resolution levels. Note that the presentation attributes listed above are exemplary and should, by no means, limit the scope of various aspects of the present invention to particular information presentation attributes.

The source throttling module 290 may utilize knowledge of the user's information consumption to establish and modify communication characteristics between various information source devices 221-223 and the information presentation system 110. The source throttling module 290 may utilize the communication module 260 to handshake with various information source devices 221-223 to establish the desired communication characteristics. Such communications characteristics may include, for example, communication stream characteristics, such as various communication protocols and sub-protocols, various spatial and temporal resolutions, various physical layer attributes, and various priority levels. Note that the various communication and communication stream characteristics listed above are exemplary and should, by no means, limit the scope of various aspects of the present invention to particular communication and communication stream characteristics.

For example, the source throttling module 290 may communicate with an information source device, which informs the source throttling module 290 that the information source device may communicate video information to the information presentation system 110 using WAV or MP3 encoding over a Bluetooth or IEEE 802.11 link. The source throttling module 290 may determine that MP3 encoding over an IEEE 802.11 link is currently the most appropriate communication strategy for the current information consumption environment.

The source throttling module 290 may make this determination for a variety of reasons. For example, the user may be currently consuming the information in a low-fidelity audio mode where the user cannot tell the difference between WAV (relatively high bandwidth) and MP3 (relatively low bandwidth) encoding. Thus, MP3 encoding may be the most bandwidth-efficient solution in the current environment. Additionally, the communication module 260 currently may have more communication resources available for IEEE 802.11 communication than for Bluetooth communication. Thus, communication over an IEEE 802.11 communication link may be the most bandwidth-efficient solution in the current environment.

To make bandwidth arbitration decisions, the source throttling module 290 may, for example, operate according to a decision algorithm. Such a decision algorithm may assume a multitude of forms. For example, the decision algorithm may be designed to always choose the lowest bandwidth option that will not reduce the user's information quality by a predetermined level. Also, for example, the decision algorithm may be designed to always allocate an amount of bandwidth corresponding to the highest quality level for communicating the user's top priority information stream. Further, for example, the decision algorithm may contain a list that cross-references window sizes to optimal encoding techniques.

As will be discussed more below, the information source devices 221-223 may then communicate information to the information presentation system 110 according to the established communications characteristics. The information source devices 221-223 may communicate the information to the communication module 260, which in turn, is coupled to the IO control system 240. Information may arrive from the various information source devices 221-223 encoded in a variety of formats. Accordingly, the I/O control system 240 may include a decoder core module 242. The decoder core module 242 may perform any necessary decoding of information arriving from the information source devices 221-223 through the communication module 260. The decoder core module 242 may then provide the decoded information to the information output system 230 (e.g., under the control of the operating system module 241) for presentation to the user.

The decoder core module 242 may, for example, have the capability to decode a large variety of various encoding schemes. For example and without limitation, the decoder core module 242 may have the capability to decode various video standards, such as SVGA and MPEG standards, and may have the capability to decode various audio standards, such as WAV and MP3. The decoder core module 242 may include a collection of various individual decoder modules or may alternatively include a decoding processor that timeshares decoding processing between various encoded information streams.

The information consumption system 110 may include various groupings of the system components and modules discussed previously. For example, the information output system 230 may be a stand-alone system, and the communication module 260, consumption detection module 280, source throttling module 290 and I/O control system 240 may reside in a separate physical unit. Such a configuration is illustrated in FIG. 2 by dashed lines 230 and 295. Alternatively, for example, all of the above-mentioned components may be housed in a single enclosure. Further, for example, numerous aspects of the information consumption system 210 may be combined in a single integrated circuit. Additionally, various aspects of the present invention may be performed with dedicated hardware or a processor executing software or firmware instructions. Accordingly, the scope of various aspects of the present invention should, by no means, be limited to particular groupings or arrangements of the various modules, nor to particular hardware or software implementations of the disclosed functionality.

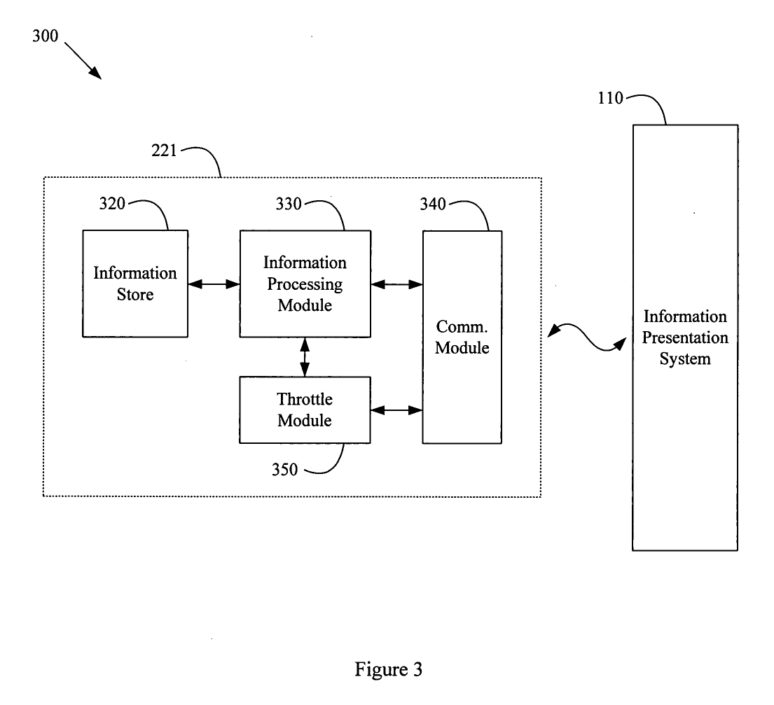

FIG. 3 is a diagram illustrating an information consumption environment 300 incorporating consumption-based source throttling in accordance with various aspects of the present invention. The information consumption environment 300 includes an information presentation system 110, which may, for example, be similar to the information presentation 110 illustrated in FIG. 2 and discussed previously. The information consumption environment 300 also includes an exemplary information source device 221, which may, for example, be similar to one of the information source devices 221-223 illustrated in FIG. 2 and discussed previously.

The exemplary information source device 221 includes a source communication module 340, which may, for example, communicate information between the information source device 221 and the information presentation system 110. The information source device 221 includes a throttle module 350 that is communicatively coupled to the source communication module 340. The throttle module 350 may utilize the source communication module 340 to communicate information with the information presentation system 110. Such information may include, for example, handshaking information communicated between the information presentation system 110 and the information source device 221 to establish appropriate characteristics of a communication stream for communicating information from the information source device 221 to the information presentation system 110 for ultimate presentation to a user. The throttle module 350 may then generate a signal indicative of determined communication stream characteristics.

The exemplary information source device 221 includes an information store 320, which may contain information for user consumption. The information store 320 may include, for example, video information, audio/video information, audio information, textual information or other information. The information source device 221 also includes an information processing module 330, which is coupled to the information store 320, throttle module 350 and communication module 340.

The information processing module 330 may receive information from the information store 320 and process the information into a communication stream. The information processing module 330 may receive from the throttle module 350 the signal indicative of determined communication stream characteristics. The information processing module 330 may then process the information from the information store 320 into a communication stream having the determined characteristics. Such communication stream characteristics may include, for example, various communication protocols and sub-protocols, various spatial and temporal resolutions, various physical layer attributes, and various priority levels. Note that the various communication and communication stream characteristics listed above are exemplary and should, by no means, limit the scope of various aspects of the present invention to particular communication and communication stream characteristics.

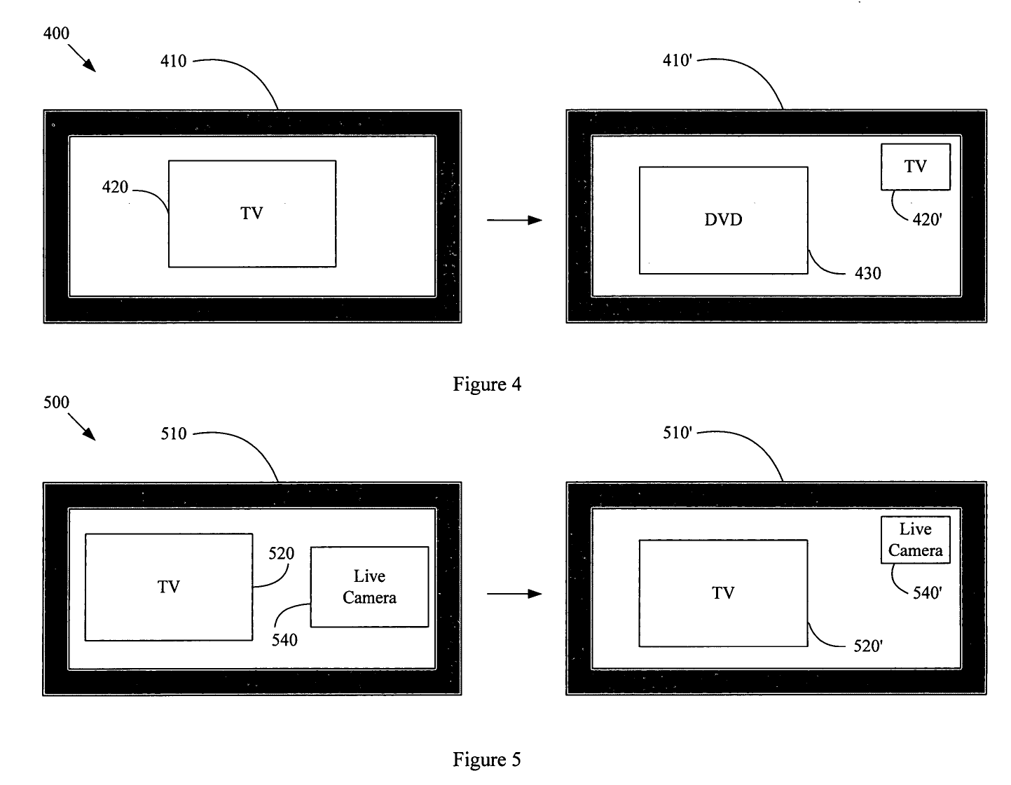

FIGS. 4-7 provide illustrative user information consumption scenarios that the following discussion will utilize to show exemplary operation of various aspects of information source devices and information presentation systems. Accordingly, the following discussion will discuss FIGS. 4-7 while referring to various aspects of the information source devices 221-223 and information presentation system 110 as discussed previously with regard to FIGS. 1-3.

FIG. 4 is a diagram illustrating a first example 400 of user information consumption in accordance with various aspects of the present invention. The user initially utilizes the information presentation system 410 to consume (i.e., in this example, view) information (e.g., a television program) in the TV window 420. The information presentation system 410 may, for example, receive the television program in a 19.8 Mbps MPEG-2 information stream transmitted from a television receiver information source device. The communication module 260 of the information presentation system 410 may communicate the received television information to the I/O control system 240, which in turn, outputs a signal to the display system 231 that causes the display system 231 to present the received television information according to an initial set of presentation attributes. The TV window 420 may have initial presentation attributes including, for example, initial dimensions and an initial display spatial resolution.

Continuing the example, the user may then modify the information consumption environment by utilizing the information presentation system 410′ to consume information (e.g., a movie) from a DVD information source device. The user directs the information presentation system 410′ to generate a DVD window 430, move the TV window 420′, and resize the TV window 420′.

The consumption detection module 280 detects the change in the user's consumption of information, including that the user has expressed the desire to consume a next portion of the television program in the resized TV window 420′, and communicates this change to the source throttling module 290. The source throttling module 290 determines, for example, that the next set of presentation attributes for the television program includes a reduced size window. The reduced size window, in turn, may correspond to a reduced relative spatial resolution for the displayed television program. In the example, the source throttling module 290 determines that continuing to communicate the television program using 19.8 Mbps MPEG-2 encoding is wasteful, since the smaller TV window 420′ cannot effectively present that quantity of information to the user. Accordingly, the source throttling module 290 communicates with the throttle module 350 of the corresponding information source device 221 to determine if there is a more efficient communication strategy available.

For example, the source throttling module 290 (and/or throttle module 350) may determine that the most appropriate available communication strategy, given the user's current information consumption, includes a 1 Mbps MPEG-2 information stream. Alternatively, for example, the source throttling module 290 may determine that the most appropriate available communication strategy includes switching from MPEG-2 to MPEG-4 encoding. The communication strategy may also include modifying communication link characteristics, such as channel, frequency, timeslot, and general bandwidth characteristics.

The source throttling module 290 may then direct the information source device 221 to communicate the next portion of the television program to the information presentation system 410′ using the next communication strategy. The information presentation system 410′ may then receive the next portion of the television program and present the next portion of the television program to the user according to the next set of presentation attributes.

In an additional example, the user may explicitly specify a change in spatial resolution for the presentation of certain information. The user may, for example, choose to reduce the resolution to explicitly free up bandwidth for the communication of other information. The information presentation system 110 may respond to such a request in the manner described above.

FIG. 5 is a diagram illustrating a second example 500 of user information consumption in accordance with various aspects of the present invention. The user initially utilizes the information presentation system 510 to consume (i.e., in this example, view) information (e.g., a television program) in the TV window 520 and a unit of live video information in the Live Camera window 540. The information presentation system 510 may, for example, receive the television program in a 19.8 Mbps MPEG-2 information stream transmitted from a television receiver information source device. The information presentation system 510 may, for example, receive the live camera information in an information stream based on SVGA information.

The communication module 260 of the information presentation system 510 may communicate the received television program information to the I/O control system 240, which in turn, outputs a signal to the display system 231 that causes the display system 231 to present the received television information according to an initial set of presentation attributes. The TV window 520 may have initial presentation attributes including, for example, initial dimensions, an initial display spatial resolution and an initial color resolution.

The communication module 260 may communicate the received live video information to the I/O control system 240, which in turn, outputs a signal to the display system 231 that causes the display system to present the received television information according to an initial set of presentation attributes. The Live Camera window 540 may have initial presentation attributes including, for example, initial dimensions, an initial display spatial resolution and an initial display temporal resolution.

Continuing the example, the user may then modify the information consumption environment by directing the information presentation system 510′ to move and resize the Live Camera window 540′ and reduce the temporal resolution of the information presented in the Live Camera window (e.g., changing from fast-scan to slow-scan). The user may specify this, for example, to conserve system communication bandwidth or to minimize the frequency of distracting image changes in the Live Camera window 540′.

The consumption detection module 280 detects the change in the user's consumption of information, including that the user has expressed the desire to consume a next portion of the live video information in the resized Live Camera window 540′ at a reduced temporal resolution, and communicates this to the source throttling module 290. The source throttling module 290 determines, for example, that the next set of presentation attributes for the live video information includes a reduced size window. The reduced size window, in turn, may correspond to a reduced relative spatial resolution for the displayed live video information. In the example, the source throttling module 290 determines that continuing to communicate the live video information using SVGA is wasteful, since the smaller TV window 420′ cannot effectively present that information to the user. Accordingly, the source throttling module 290 communicates with the throttle module 350 of the corresponding information source device 221 to determine if there is a more efficient communication strategy available.

For example, the source throttling module 290 (and/or throttle module 350) may determine that the most appropriate available communication strategy, given the user's current information consumption, includes a VGA-based information stream, segmented to communicate an updated image to the user every fifteen seconds. The communication strategy may also include modifying communication link characteristics, such as channel, frequency, timeslot, and general bandwidth characteristics.

The source throttling module 290 may then direct the information source device to communicate the next portion of the live video information to the information presentation system 510′ using the next communication strategy. The information presentation system 510′ may then receive the next portion of the live video information and present the next portion of the live video information to the user according to the next set of presentation attributes.

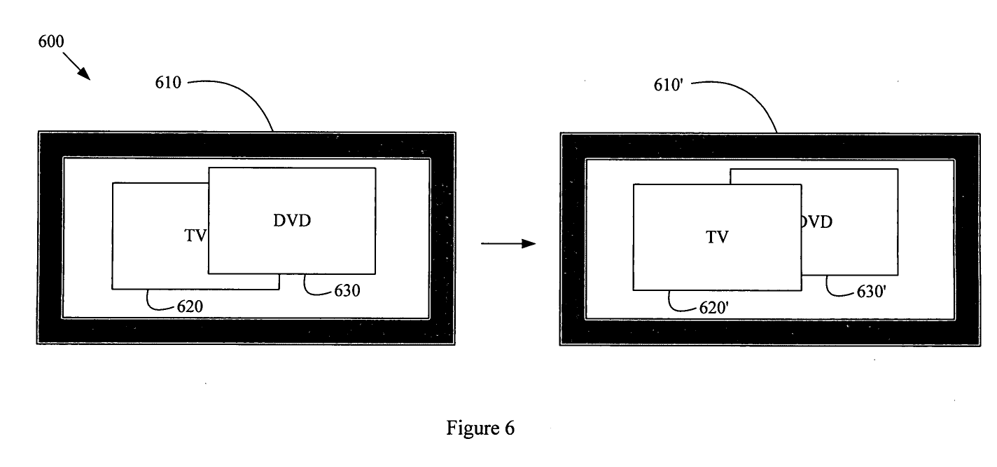

FIG. 6 is a diagram illustrating a third example 600 of user information consumption in accordance with various aspects of the present invention. The user initially utilizes the information presentation system 510 to consume (i.e., in this example, view) information (e.g., a television program) in the TV window 620 and other information (e.g., a movie) in the DVD window 630. The information presentation system 610 may, for example, receive the television program in a MPEG-2 information stream transmitted from a television receiver information source device. The information presentation system 610 may, for example, receive the movie in a MPEG-4 information stream. In the initial information consumption environment, the user has placed the DVD window 630 in a layered configuration on top of the TV window 620. In this example, such a layering is indicative of assigning a higher priority to information corresponding to the top window (i.e., the television window).

The communication module 260 of the information presentation system 610 may communicate the received television program information to the I/O control system 240, which in turn, outputs a signal to the display system 231 that causes the display system 231 to present the received television information according to an initial set of presentation attributes. The TV window 620 may have initial presentation attributes including, for example, initial dimensions, an initial display spatial resolution and an initial color resolution. The presentation attributes may also include an indication of priority (relative or absolute), which the information presentation system 610 may utilize to prioritize communications between the information presentation system 610 and the corresponding information source device.

The communication module 260 may communicate the received DVD information to the I/O control system 240, which in turn, outputs a signal to the display system 231 that causes the display system to present the received television information according to an initial set of presentation attributes. The DVD window 630 may have initial presentation attributes including, for example, initial dimensions, an initial display spatial resolution and an initial color resolution. The presentation attributes may also include an indication of priority, which the information presentation system 610 may utilize to prioritize communications between the information presentation system 610 and the corresponding information source device.

Based on the respective priority levels between the TV window 620 and the DVD window 630, the information presentation system 610 (e.g., the source throttling module 290) may assign characteristics to the information streams from the television information source device and the DVD information source device that favor the higher-priority information source device. For example, since in the initial user consumption environment, the DVD window 630 has a higher priority than the TV window 620, the information presentation system 610 may assign 19.8 Mbps MPEG-2 stream characteristics for communications with the DVD information source device and 1 Mbps MPEG-2 stream characteristics for communications with the television information source device.

Continuing the example, the user may then modify the information consumption environment by directing the information presentation system 610′ to modify the window layering, placing the TV window 620′ on top of the DVD window 630′. The user may alternatively, for example, explicitly alter or assign priority levels to various windows. The consumption detection module 280 detects the change in the user's consumption of information, including that the user has effectively altered the priority level between the TV window 620′ and the DVD window 630′, and communicates this to the source throttling module 290.

The source throttling module 290 determines, for example, that the next set of presentation attributes for the information in the TV window 620′ include a higher priority level and the next set of presentation attributes for the information in the DVD window 630 include a lower priority level. Accordingly, the source throttling module 290 may communicate with the throttle module 350 of the corresponding information source device 221 to determine if there is a more efficient communication strategy available.

For example, the source throttling module 290 (and/or throttle module 350) may determine that the most appropriate available communication strategy, given the user's current information consumption, includes modifying the communication link characteristics for the communication links corresponding to the TV window 620′ and the DVD window 630. For example, the source throttling module 290 may decide to modify the respective communications such that the television information resource device communicates with the information presentation system 610′ using 19.8 Mbps MPEG-2 encoding and the DVD information resource device communicates with the information presentation system 610′ using 1 Mbps MPEG-2 encoding. The communication strategy may also include modifying communication link characteristics, such as channel, frequency, timeslot, and general bandwidth characteristics.

The source throttling module 290 may then direct the respective information source devices to communicate the next portions of the television and DVD information to the information presentation system 610′ using the next communication strategy. The information presentation system 610′ may then receive the next portions of the television and DVD information and present the next portions of the television and DVD information to the user according to the next set of presentation attributes.

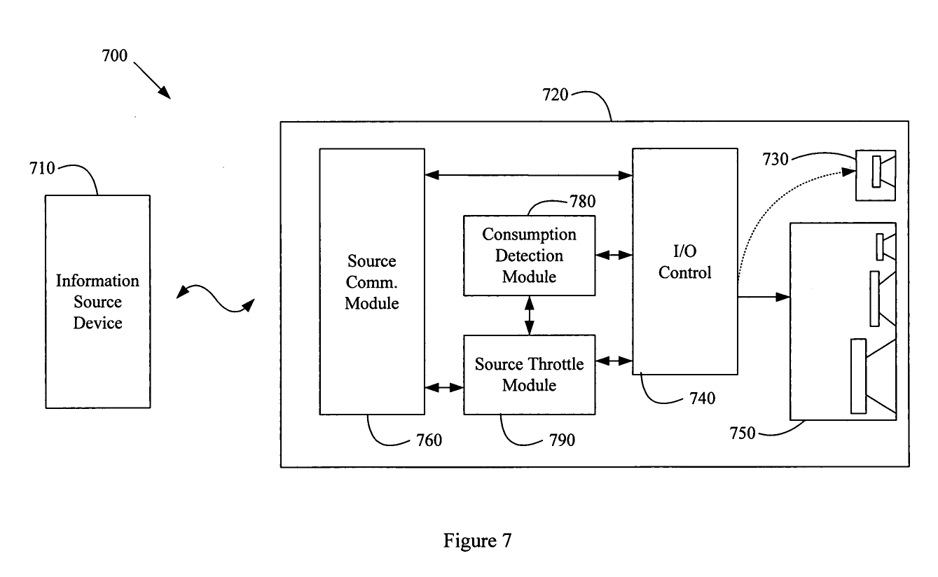

FIG. 7 is a diagram illustrating a fourth example 700 of user information consumption in accordance with various aspects of the present invention. The fourth example 700 illustrates an audio information consumption scenario. The exemplary information consumption environment includes an audio information source device 710 and an audio information presentation system 720. The audio information presentation system 720 includes a first audio output system 730 and a second audio output system 750. The audio information presentation system 720 also includes an I/O controller 740, consumption detection module 780, source throttling module 790 and communication module 760. Various aspects of the exemplary audio information presentation system 720 may be similar to various aspects of the various information presentation systems discussed thus far.

In an initial audio information consumption environment, the user has directed the audio output in the audio information presentation system 720 to first audio output system 730, which may be, for example, a relatively low fidelity speaker system. The consumption detection module 780, which is communicatively coupled to the I/O Control Module 740, may detect that the user is utilizing the relatively low fidelity first audio output system 730. The consumption detection module 780 may generate a signal indicative of this characteristic (among others) of the user's consumption.

The source throttling module 790, which is communicatively coupled to the consumption detection module 780, may utilize the communication module 760 to communicate with the information source device 710 and determine that the information source device 710 may effectively communicate the desired audio information to the audio information presentation system 720 using, for example, 64 Kbps MP3 encoding. The source throttling module 790 may communicate a request (or command) to the audio information source device 710 (e.g., to a throttle module in the audio information source device 710). The audio information source device 710 may then communicate audio information to the audio information source device 720 using 64 Kbps MP3 encoding.

Continuing with the example, the user then switches the audio output from the I/O control module 740 from the relatively low fidelity first audio output system 730 to the second audio output system 750, which is relatively high fidelity. The consumption detection module 780 may detect this change in user consumption and communicate the change to the source throttling module 790. The source throttling module 790 may then, in turn, communicate with the information source device 710 to determine that a different communication method is appropriate. For example, the source throttling module 790 may determine that audio information encoded in the WAV format is appropriate for the user's current consumption. Accordingly, the source throttling module 790 may communicate a request (or command) to the audio information source device 710 (e.g., to a throttle module in the audio information source device 710). The audio information source device 710 may then modify the characteristics of the audio stream communicated to the audio information presentation system 720. For example, the audio information source device 710 may communicate WAV-encoded audio information in an audio communication stream.

Though the previous example was directed to an audio consumption scenario, the example should, by no means, limit the scope of various aspects of the present invention to an audio environment. For example and without limitation, a user may direct video output information to various devices with respective output capabilities.

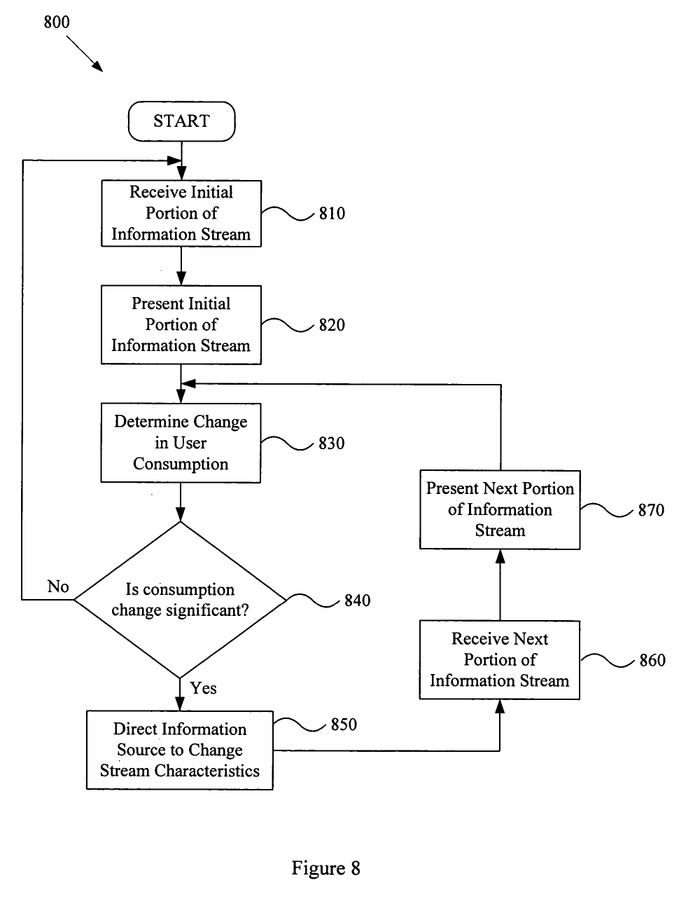

FIG. 8 is a flow diagram illustrating a method 800 incorporating consumption-based source throttling in accordance with various aspects of the present invention. Various aspects of the method 800 may, for example, be implemented using the various components shown in the information consumption environments 200, 300 shown in FIGS. 2 and 3 and discussed previously. The exemplary method 800 generally includes performing consumption-based source throttling in an information consumption system (or “user output system”), such as, for example, an audio/visual display system or audio presentation system.

The method 800 includes receiving an initial portion of an information stream at step 810. The information stream may be received from any of a large variety of devices that can provide information to a user for consumption. The information stream may be one of many information streams. For example and without limitation, information source devices may include television receivers, personal computers, cellular phones, digital video disk players, pagers, telephones, personal digital assistants, pocket computers, cameras, door bells, laptop computers, intercom systems, radios, portable music players, etc.

The information source devices may communicate their respective information over a large variety of communication protocols and standards. For example, the information source devices may communicate information over wireless links, wired links, optical cable links, and non-tethered optical cable links. Accordingly, the scope of various aspects of the present invention should, by no means, be limited to particular types of information source devices or particular communication media or protocols. Step 810 may include receiving an initial information stream having a set of initial stream characteristics. Such characteristics may include, for example, encoding type, channel allocation, spatial and temporal resolution, communication protocol, priority level and data rate.

The method 800 includes presenting the initial portion of the information stream at step 820. Step 820 may include presenting the initial portion of the information stream to a user according to an initial set of presentation attributes. Such presentation attributes may include, for example, window size, spatial resolution, temporal resolution, color and sound resolution, display or audio quality, and priority level. The user may have previously defined the initial presentation attributes, or the initial presentation attributes may be set to default levels.

The method 800 includes determining that a change in the user's information consumption has occurred at step 830. Such a change may be, for example, a change in window size and location, a change in window layering, a change in audio or video output device, or an explicit command to modify resolution or quality.

The method 800 further includes determining whether a received indication of user information consumption represents a change in the user's information consumption that is significant enough to warrant modifying information stream characteristics at step 840. Such stream characteristics may include, for example, encoding type, channel allocation, spatial and temporal resolution, communication protocol, priority level and data rate.

Step 840 may include, for example, analyzing a signal indicative of the user's consumption of information to determine whether a change in information stream characteristics is necessary. For example, for a slight modification to the size of a viewing window, there may be no significant advantage to changing information stream characteristics. Also, for example, for a reprioritization of viewing windows in an environment where there is no shortage of communication bandwidth, there may be no significant advantage to changing the information stream characteristics.

If, at step 840, the method 800 determines that there is no change in the user's information consumption significant enough to warrant a change in communication stream characteristics, the method 800 flow returns to step 810. At step 810, the method 800 may continue to receive the information stream according to the initial stream characteristics. If, however, at step 840, the method 800 determines that there is a significant change in the user's information consumption, then method 800 flow continues to step 850.

Method step 850 may include directing an information source device to modify characteristics of an information stream that the information source device is transmitting. Step 850 may include directing an information source device to modify stream characteristics, including, for example, encoding type, frequency or channel, spatial and temporal resolution, communication protocol, priority level and data rate. After directing the information source device, at step 850, to transmit a next portion of the information stream according to a next set of stream characteristics, the method 800 receives the next portion of information at step 860. Step 860 may, for example, include receiving a next information stream that has been encoded according to a new encoding scheme, communicated using a new communication protocol, and transmitted using a different data rate.

The method 800 may then, at step 870, present the next portion of information to the user according to the next set of presentation attributes that the method 800 determined in step 830. The method 800 flow then continues at step 830 to detect further changes in user consumption.

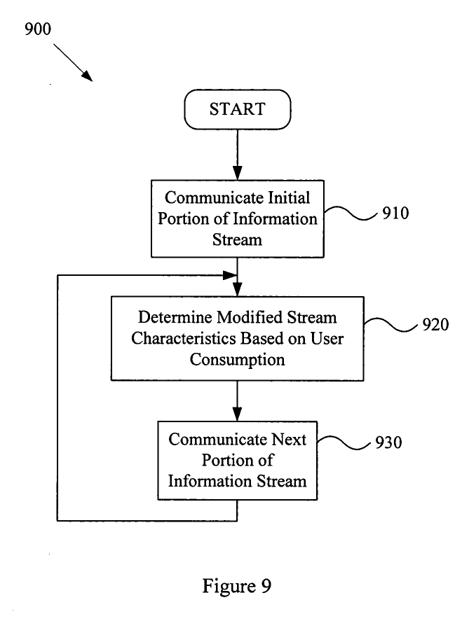

FIG. 9 is a flow diagram illustrating a method 900 incorporating consumption-based source throttling in accordance with various aspects of the present invention. The exemplary method 900 includes various aspects of the present invention that may, for example, be utilized in an information source device. The method 900 includes communicating, at step 910, an initial portion of information to an information presentation system, such as, for example, an audio/video display system or an audio output system. Step 910 may include communicating the initial portion of information in an information stream having an initial set of stream characteristics, such as the stream characteristics described previously.

The method 900 next may include determining modified information stream characteristics at step 920. Step 920 may include, for example, communicating with an information presentation system that is tracking a user's consumption of information. Step 920 may include, for example, an information source device handshaking with an information presentation system to arrive at the most appropriate information stream characteristics according to the current information consumption environment.

The method 900 may next include communicating a next portion of the information stream according to the modified stream characteristics. Such next modified stream characteristics may be as those discussed previously. The method 900 flow may then flow back to step 920 to await a next change in the user consumption environment.

In summary, aspects of the present invention provide a system and method for consumption-based communication control in a dynamic information consumption environment.

While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An information presentation system, comprising:
a communication module that receives an information stream from an information source device, an initial portion of the information stream being based on an initial portion of information and initial stream characteristics;
an output module, communicatively coupled to the communication module, that generates a signal that causes the initial portion of the information to be presented in human-perceivable form according to initial presentation attributes;
a consumption detection module that determines when a user desires a next portion of the information to be presented in human-perceivable form according to next presentation attributes, and generates a signal indicative of the next presentation attributes;
a source throttling module, communicatively coupled to the consumption detection module and the communication module, that receives the signal indicative of the next presentation attributes and generates a signal directing the information source device to communicate the next portion of the information to the information presentation system according to next stream characteristics, which are based on the next presentation attributes.

2. The system of claim 1, wherein:
the output module generates a signal that causes the initial portion of the information to be presented in a video display window; and
the consumption detection module determines that a user desires the next portion of the information to be presented according to the next presentation attributes when the user has modified a dimension of the video display window.

3. The system of claim 1, wherein the consumption detection module determines that a user desires the next portion of the information to be presented according to the next presentation attributes when the user changes the spatial resolution at which the user is consuming the information.

4. The system of claim 1, wherein the consumption detection module determines that a user desires the next portion of the information to be presented according to the next set of presentation attributes when the user changes the temporal resolution at which the user is consuming the information.

5. The system of claim 1, wherein the consumption detection module determines that a user desires the next portion of the information to be presented according to the next set of presentation attributes when the user changes the priority level at which the user is consuming the information.

6. The system of claim 1, wherein the consumption detection module determines that a user desires the next portion of the information to be presented according to the next set of presentation attributes when the consumption detection module determines that the information presentation system is incapable of adequately presenting the initial portion of the information according to the initial set of presentation attributes.

7. The system of claim 1, wherein the consumption detection module determines that a user desires the next portion of the information to be presented according to the next set of presentation attributes when the user changes the quality level at which the user is consuming the information.

8. The system of claim 1, wherein the initial stream characteristics comprise an initial communication protocol, and the next stream characteristics comprise a next communication protocol that is different than the initial communication protocol.

9. The system of claim 1, wherein the initial stream characteristics comprise an initial spatial resolution level, and the next stream characteristics comprise a next spatial resolution level that is different than the initial spatial resolution level.

10. The system of claim 1, wherein the initial stream characteristics comprise an initial temporal resolution level, and the next stream characteristics comprise a next temporal resolution level that is different than the initial temporal resolution level.

11. The system of claim 1, wherein the initial stream characteristics comprise an initial information encoding scheme, and the next stream characteristics comprise a next information encoding scheme that is different than the initial information encoding scheme.

12. An information source system, comprising:
an information processing module that generates an initial portion of an information stream based on an initial portion of information, the initial portion of the information stream being based on initial stream characteristics;
a communication module, communicatively coupled to the information processing module, that communicates the information stream to an information destination system; and
a throttle module, communicatively coupled to the communication module and the information processing module, that communicates with the information destination system during communication of the information stream to determine modifications to the initial stream characteristics based on user consumption of information carried in the information stream, and generates a signal indicative of next stream characteristics, the next stream characteristics being based on user consumption of information carried in the information stream and different than the initial stream characteristics;
the information processing module receives the signal indicative of the next stream characteristics and generates a next portion of the information stream based on a next portion of the information and the next stream characteristics.

13. The system of claim 12, wherein the initial stream characteristics comprise an initial communication protocol, and the next stream characteristics comprise a next communication protocol that is different than the initial communication protocol.

14. The system of claim 12, wherein the initial stream characteristics comprise an initial spatial resolution level, and the next stream characteristics comprise a next spatial resolution level that is different than the initial spatial resolution level.

15. The system of claim 12, wherein the initial stream characteristics comprise an initial temporal resolution level, and the next stream characteristics comprise a next temporal resolution level that is different than the initial temporal resolution level.

16. The system of claim 12, wherein the initial stream characteristics comprise an initial information encoding scheme, and the next stream characteristics comprise a next information encoding scheme that is different than the initial information encoding scheme.

17. In an information presentation system that receives information from an information source device and presents the information in human-perceivable form, a method for controlling the manner in which the information source device communicates information to the information presentation system, the method comprising:
receiving an information stream from the information source device, the information stream carrying an initial portion of information and characterized by initial stream characteristics;
presenting the initial portion of the information in human-perceivable form according to an initial set of presentation attributes;
determining that a user desires to consume a next portion of the information according to a next set of presentation attributes;
directing the information source device to communicate the next portion of the information in the information stream characterized by next stream characteristics, which are based on the second set of presentation attributes.

18. The method of claim 17, wherein:
presenting the initial portion of the information comprises presenting the initial portion of the information in a video display window; and
determining that a user desires to consume a next portion of the information according to a next set of presentation attributes, comprises determining that the user has modified a dimension of the video display window.

19. The method of claim 17, wherein determining that a user desires to consume a next portion of the information according to a next set of presentation attributes comprises determining that the user has modified the spatial resolution at which the user is consuming the information.

20. The method of claim 17, wherein determining that a user desires to consume a next portion of the information according to a next set of presentation attributes comprises determining that the user has modified the temporal resolution at which the user is consuming the information.

21. The method of claim 17, wherein determining that a user desires to consume a next portion of the information according to a next set of presentation attributes comprises determining that the user has modified the priority at which the user is consuming the information.

22. The method of claim 17, wherein determining that a user desires to consume a next portion of the information according to a next set of presentation attributes comprises determining that the information presentation system is incapable of adequately presenting the initial portion of the information according to the initial set of presentation attributes.

23. The method of claim 17, wherein determining that a user desires to consume a next portion of the information according to a next set of presentation attributes comprises determining that the user has modified the quality level at which the user is consuming the information.

24. The method of claim 17, wherein the initial stream characteristics comprise an initial communication protocol, and the next stream characteristics comprise a next communication protocol that is different than the initial communication protocol.

25. The method of claim 17, wherein the initial stream characteristics comprise an initial spatial resolution level, and the next stream characteristics comprise a next spatial resolution level that is different than the initial spatial resolution level.

26. The method of claim 17, wherein the initial stream characteristics comprise an initial temporal resolution level, and the next stream characteristics comprise a next temporal resolution level that is different than the initial temporal resolution level.

27. The method of claim 17, wherein the initial stream characteristics comprise an initial information encoding scheme, and the next stream characteristics comprise a next information encoding scheme that is different than the initial information encoding scheme.

28. In an information source system that provides information to an information presentation system, a method for controlling the manner in which the information source system communicates information to the information presentation system, the method comprising:
communicating an initial portion of the information to the information presentation system in an information stream characterized by initial stream characteristics;
receiving an indication from the information presentation system to communicate a next portion of the information to the information presentation system in an information stream characterized by next stream characteristics; and
communicating the next portion of the information to the information presentation system in an information stream characterized by the next stream characteristics.

29. The method of claim 28, wherein the initial stream characteristics comprise an initial communication protocol, and the next stream characteristics comprise a next communication protocol that is different than the initial communication protocol.

30. The method of claim 28, wherein the initial stream characteristics comprise an initial spatial resolution level, and the next stream characteristics comprise a next spatial resolution level that is different than the initial spatial resolution level.

31. The method of claim 28, wherein the initial stream characteristics comprise an initial temporal resolution level, and the next stream characteristics comprise a next temporal resolution level that is different than the initial temporal resolution level.

32. The method of claim 28, wherein the initial stream characteristics comprise an initial information encoding scheme, and the next stream characteristics comprise a next information encoding scheme that is different than the initial information encoding scheme.

33. The method of claim 28, wherein the indication comprises information based on an expressed user desire to modify presentation attributes for the information.
